(19) United States
(12) Patent Application Publication
(10) Pub. No.: US 2016/0297991 A1
(43) Pub. Date: Oct. 13, 2016

(54) Coating Composition in the Form of a Non-Aqueous Transparent Dispersion

(71) Applicant: DRITTE PATENTPORTFOLIO BETEILIGUNGSGESELLSCHAFT MBH & CO KG, Schonefeld/Waltersdorf (DE)

(72) Inventor: Kirsten Siebertz, Nidderau (DE)

(21) Appl. No.: 15/103,667

(22) PCT Filed: Dec. 12, 2014
(86) PCT No.: PCT/EP2014/077510

§ 371 Date: Jun. 10, 2016

(30) Foreign Application Priority Data
Dec. 12, 2013 (DE) 102013020915.3
Mar. 20, 2014 (EP) 14160872.9

(51) Int. Cl. C09D 175/16; B05D 3/06

(52) U.S. Cl. CPC C09D 175/16; B05D 3/067

(57) ABSTRACT

The invention relates to a coating composition in the form of a non-aqueous transparent dispersion, comprising a reactive diluent, polyurethane (meth)acrylate particles, which can be obtained by reacting a polyisocyanate with a polyol and a nucleophilically functionalized (meth)acrylic acid ester in the reactive diluent in order to form polyurethane (meth)acrylate particles having a mean diameter of less than 40 nm, and an initiator. Corresponding coating compositions are distinguished by especially favorable properties in particular with regard to the adhesive strength, hardness, and microscratch resistance of said coating compositions after the curing of said coating compositions and therefore are superior to conventionally available coating product without nanoparticulate polyurethane (meth)acrylate particles in many cases.

### CROSS-REFERENCE TO RELATED APPLICATIONS

This application filed Jun. 20, 2016, which is the U.S. National Stage of International Application PCT/EP2014/077510 filed Dec. 14, 2014, which claims the benefit of DE. Application No. 102013020915.3 filed Dec. 12, 2013 and EP 14160872.9 filed Mar. 20, 2014; all of which are hereby incorporated herein in their entirety by reference.

### DESCRIPTION

The invention relates to coating compositions in the form of non-aqueous transparent dispersions which contain a reactive diluent, polyurethane (meth)acrylate particles which can be obtained by reacting a polyisocyanate with a polyol and a nucleophilically functionalised (meth)acrylic ester in the reactive diluent, and have an average diameter of less than 40 nm, and also contain an initiator.

In recent years, non-aqueous polyurethane dispersions have become increasingly important. They are used, inter alia, as coating, bonding and adhesive agents.

DE 32 48 132, DE 35 13 248, EP 0 320 690 and EP 0 318 939 describe non-aqueous dispersions of polyurethanes which are to be used mainly as coating agents. The solvent consists of a hydrocarbon. Curing takes place by evaporation of the solvent, as a result of which a thin layer of the previously dispersed polyurethane particles is formed. The dispersion of DE 32 48 132 is described as being impervious to light (opaque).

DE 10 2005 035 235 A1 describes non-aqueous transparent dispersions of polyurethane (meth)acrylate particles in a reactive diluent which can be obtained by reacting a polyisocyanate with at least one polyol and a nucleophilically functionalised (meth)acrylic ester in the reactive diluent and which are characterised in that the polyurethane (meth)acrylate particles have an average diameter of less than 40 nm. DE 10 2005 035 235 A1 describes corresponding compositions to be used as adhesive systems and casting compounds and states that the dispersions which have cured to produce a solid body have outstanding impact toughness characteristics and a high combined tension and shear resistance.

However, the compositions described in this application have characteristics which are unsatisfactory especially for coating uses, such as an unfavourable viscosity, inter alia. Thus, there is a need for compositions for coating uses which, after curing, are completely transparent and which at the same time have an improved characteristic profile in respect of use characteristics, specifically their adhesive strength, hardness and resistance to micro-scratches. These characteristics are especially significant when the compositions are used as a coating, because on the one hand coatings should be as transparent as possible, while on the other they should effectively shield and protect the underlying substrate or product against external influences so that it is not damaged as a result of daily use.

In view of the prior art, the aim of the present invention was to provide coating compositions based on polyurethane dispersions which have improved characteristics over the prior art and, in addition to a high transparency after curing, have a favourable adhesive strength, hardness and resistance to micro-scratches. A further aim was to provide a dispersion which can be obtained from as few components as possible in order to simplify the production of corresponding dispersions. Furthermore, as far as possible the dispersion according to the invention should be produced with components which can be obtained easily and economically.

A further aim of the present invention was to also provide adhesive formulations and coating formulations based on polyurethane dispersions which have improved characteristics over the prior art and, in addition to a high transparency after curing, have a high impact strength and combined tension and shear strength. Thus, in particular it should be possible to be able to dispense with the addition of external stabilisers, without the stability of the dispersion being adversely affected.

The previously stated aims as well as further aims which, although not mentioned literally, can be derived from the connections discussed here and result inevitably therefrom, are achieved by a coating composition in the form of a non-aqueous transparent dispersion which comprises the following:
a reactive diluent
polyurethane (meth)acrylate particles obtainable by reacting at least one polyisocyanate with at least one polyol and at least one nucleophilically functionalised (meth)acrylic ester in the reactive diluent to produce polyurethane (meth)acrylate particles having an average diameter of less than 40 nm, and
an initiator.

Thus, the present invention provides a coating composition in the form of a non-aqueous transparent dispersion which contains on the one hand polyurethane (meth)acrylate particles functionalised with methacrylic esters and on the other hand a reactive diluent as well as an initiator, by which it is possible to bind the functionalised polyurethane (meth)acrylate particles during the polymerisation of the reactive diluent covalently into the matrix of the reactive diluent. An advantage of such coating compositions is that they are transparent and they also remain transparent after the reactive diluent has cured.

The coating composition according to the invention can be used directly as a coating, although it is also possible to mix into the composition further additives which are usual in coatings, or to mix the composition with commercially available coating compositions and to use the formulation obtained therefrom as a coating.

In the form of the cured dispersion, the coating according to the invention has an outstanding adhesive strength on various substrates, an excellent hardness and also a good resistance to micro-scratches, provided by the polyurethane (meth)acrylate particles which are contained therein.

A further advantage of the described dispersions is that they are stable for a relatively long time, i.e. for at least two months at room temperature and therefore they can be stored.

In the context of this invention, the expression “nucleophilically functionalised (meth)acrylic ester” denotes a (meth)acrylic ester which carries in its radical originating from the alcohol a nucleophilic functional group which reacts with free isocyanate groups. Preferred nucleophilic groups are hydroxy, amino and mercapto groups. A hydroxy group is especially preferred. The especially preferred nucleophilically functionalised (meth)acrylic esters having a hydroxy functionality are known as “hydroxyfunctional (meth)acrylic esters”.

In the context of this invention, the term “polyurethane (meth)acrylate” denotes a polyurethane, the free terminal isocyanate groups of which have been reacted with a nucleophilically functionalised (meth)acrylate acid ester. In this respect, the isocyanate groups react with the nucleophilic group of the nucleophilically functionalised (meth)acrylic ester, for example hydroxy, amino or mercapto groups, and terminal, ethylenically unsaturated functionalities are formed which are derived from (meth)acrylates. In the present context, the term “(meth)acrylic acid” denotes methacrylic acid, acrylic acid as well as mixtures of these acids. Since the nucleophilically functionalised (meth)acrylic esters react with the free isocyanate groups of the polyurethane, i.e., they “cap” them, they are also known as “capping reagents”.

According to the invention, the term “reactive diluent” is understood as meaning a substance which receives at least one ethylenic double bond. The reactive diluent fulfils the following functions:
1) The reactive diluent serves as a liquid reaction medium for the reaction of polyisocyanate with at least one polyol and a nucleophilically functionalised (meth)acrylic ester. The reactive diluent does not take part in the mentioned reaction.
2) At the end of the reaction described under 1), the reactive diluent is the liquid dispersant for the functionalised polyurethane (meth)acrylate particles which have formed.
3) In a further step, the reactive diluent can be cured by polymerisation and, at the end of the reaction, the previously formed polyurethane (meth)acrylate particles are embedded in the cured reactive diluent.

In the context of this invention, the product which is obtained at the end of step 3) is also known as a “cured dispersion”.

The polyurethane (meth)acrylate particles are embedded in the cured dispersion by polymerising the terminal, ethylenically unsaturated functionalities of the particles in the macromolecules of the polymerised matrix, the polymerised reactive diluent being understood as the “polymerised matrix”.

In the context of the present invention, the reactive diluent is not subject to any relevant restrictions, except that as far as possible, it should not have any functional groups which are reactive to polyisocyanates. Suitable reactive diluents are mentioned, for example in DE 10 2005 035 235 A1 in [0031].

In the context of the present invention, it has proved to be favourable if the reactive diluent comprises a polyfunctional (meth)acrylate. It is preferred if this polyfunctional (meth)acrylate is a difunctional (meth)acrylate. In this connection, di(meth)acrylates which are especially suitable are the di(meth)acrylates of propanediol, butanediol, hexanediol, octanediol, nonanediol, decanediol and eikosanediol. Further suitable difunctional (meth)acrylates are the di(meth)acrylate of ethylene glycol, diethylene glycol, triethylene glycol, tetraethylene glycol, dodecaethylene glycol, tetradecaethylene glycol, propylene glycol, dipropylene glycol and tetradecapropylene glycol as well as glycerol di(meth)acrylate, 2,2′-bis[p-(γ-methacryloxy-β-hydroxypropoxy)phenylpropane] or bis-GMA, bispenol A-dimethacrylate, neopentylglycoldi(meth)acrylate, 2,2′-di(4-methacryloxypolyethoxyphenyl)propane having 2 to 10 ethoxy groups per molecule and 1,2-bis(3-methacryloxy-2-hydroxypropoxy)butane. Suitable tri- or polyfunctional (meth)acrylates are for example trimethylolpropanetri(meth)acrylate and pentaerythritol tetra(meth)acrylate.

It is also possible to use polar monomers as reactive diluents, for example polar monomers having hydroxyl groups, to improve the adhesion. However, in this respect, it should be considered that monomers which contain hydroxyl groups for example can enter into reactions with isocyanates. Therefore, such monomers can be added to the dispersion only after the polyaddition step. The quantity of such polar monomers is expediently limited so as not to needlessly increase the susceptibility to water swelling. Polar, in particular hydroxyl group-containing monomers which are not bound covalently to the polyurethane (meth)acrylate particles and are thus to be distinguished in their function from the nucleophilically functionalised (meth)acrylic esters, are especially preferably used in quantities of at most 0.1 to 20% by weight, based on the total weight of the reactive diluent.

However, as stated above, it is preferred if no monomers of this type are contained as constituents of the reactive diluent in the coating compositions according to the invention.

In the context of the present invention, it is expedient if the content of polyfunctional (meth)acrylates is at least 20% by weight, in particular at least 30% by weight, preferably at least 40% by weight, more preferably at least 50% by weight, even more preferably at least 70% by weight and most preferably at least 90% by weight, based on the weight of the reactive diluent. In a preferred embodiment, the reactive diluent consists only of polyfunctional (meth)acrylates, and more preferably consists only of difunctional (meth)acrylates.

Furthermore, a reactive diluent based on (meth)acrylates can contain comonomers which are copolymerisable with (meth)acrylates. These include, inter alia, vinylester, vinylchloride, vinylidene chloride, vinylacetate, styrene, substituted styrenes with an alkyl substituent in the side chain such as α-methylstyrene and α-ethylstyrene, substituted styrenes with an alkyl substituent on the ring, for example vinyltoluene and p-methylstyrene, halogenated styrenes, such as monochlorostyrenes, dichlorostyrenes, tribromostyrenes or tetrabromostyrenes, vinyl- and isoprenylether, maleic acid derivatives, such as maleic acid anhydride, methyl maleic acid anhydride, maleinimide, methylmaleinimide, phenylmaleinimide and cyclohexylmaleinimide, and dienes, such as 1,3-butadiene, divinylbenzene, diallylphthalate and 1,4-butanediol divinylether.

The content of the above-mentioned comonomers is limited to 40% by weight of the reactive diluent, as otherwise the mechanical characteristics of the hardened dispersion can be adversely affected. The content of vinyl aromatics is limited to 30% by weight of the reactive diluent, because higher contents can lead to a separation of the system and thus to clouding.

Accordingly, the reactive diluent is especially preferably composed of
0 to 40 parts by weight of monofunctional (meth)acrylate,
0 to 40 parts by weight of comonomer and
60 to 100 parts by weight of polyfunctional (meth)acrylate.

In the context of the present invention, polyisocyanates denote low-molecular compounds which contain in the molecule two or more isocyanate groups. Diisocyanates are preferably used in the present invention.

In particular embodiments, polyisocyanates having three or more isocyanate groups can also be added. The characteristic spectrum of elongation at tear and tear strength can be adjusted by the selection of the content of polyisocyanates having three or more isocyanate groups. The higher the content of compounds having three of more functionalities, the greater the tear strength. However, here the elongation at tear is significantly reduced. Accordingly, it has been found that the content of polyisocyanates having three or more functionalities should not be greater than 10% by weight, preferably not greater than 5% by weight, based on the total mass of polyisocyanates.

Polyisocyanates which are suitable within the context of the present invention are mentioned, for example in [0046] of DE 10 2005 035 235 A1. However, it is preferred within the context of the present invention if the polyisocyanate to be included in the polyurethane (meth)acrylate particles is an aliphatic isocyanate, such as 4,4′- and 2,4′-methylene dicyclohexyl diisocyanate, hexamethylene diisocyanate or isophorone diisocyanate (IPDI). The polyisocyanate is most preferably a cycloaliphatic polyisocyanate, such as isophorone diisocyanate.

Suitable polyisocyanates can also be obtained, for example by reacting polyhydric alcohols with diisocyanates or by the polymerisation of diisocyanates. Furthermore, it is also possible to use polyisocyanates which can be prepared by reacting hexamethylene diisocyanates with small quantities of water. These products contain biuret groups.

All the mentioned isocyanates can be used on their own or as a mixture.

As stated above, the isocyanate is reacted with at least one polyol. In the context of the present invention, a polyol is understood as meaning a compound having at least two hydroxy functionalities. The polyol can have a uniform molecular weight or a statistical distribution of the molecular weight.

The polyol is preferably a high molecular weight polyol with a statistical molar-mass distribution. In this sense, a “high molecular weight polyol” is understood in the context of the present invention as meaning a polyol having two or more hydroxy groups, the weight average of the molecular weight of the high molecular weight polyol being within a range of >500 to approximately 20,000 g/mol. It is preferably within a range of >500 to 15,000 g/mol, expediently within a range of >500 to 10,000 g/mol and most preferably within a range of >500 to 5,000 g/mol, measured by gel permeation chromatography (GPC).

Polyether polyols are examples of high molecular weight polyols. An example of polyether polyols is provided by polyalkylene ether polyols of the structural formula

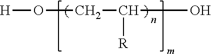

wherein the substituent R represents hydrogen or a lower alkyl group having 1-5 carbon atoms, including mixed substituents, n is typically 0 to 6 and m is 2 to 100 or can also be even higher. Included are the poly(oxytetramethylene) glycols (=polytetramethylene ether glycol=polytetrahydrofuran), poly(oxyethylene) glycols, poly(oxy-1,2-propylene) glycols and the reaction products of ethylene glycol with a mixture of 1,2-propylene oxide, ethylene oxide and alkyl glycidyl ethers.

Polytetrahydrofuran is an especially preferred polyol. It can be obtained, for example from BASF under the trade name ®PTHF 650 or ®PTHF 2000. A polyol which is most especially preferred within the context of the present invention is ®PTHF 2000.

Polyether polyols which have at least three hydroxyl functionalities can also be used. In order to obtain at least three hydroxyl functionalities which can react with isocyanate groups, alcohols, for example, which have at least three hydroxyl groups can be used as starting molecules. Included here, inter alia, are glycerol, trimethylolpropane, erythritol, pentaerythritol, sorbitol and inositol, glycerol being preferred. A preferred trifunctional polyol is a trifunctional polypropylene etherpolyol of propylene oxide, ethylene oxide and glycerol. A polyol of this type is marketed under the name Baycoll® BT 5035 by Bayer.

Copolyester diols, i.e. linear copolyesters having terminal primary hydroxyl groups can also be used as high molecular weight polyols. The average molecular weight thereof, determined by means of GPC, is preferably from 3000-5000 g/mol. They can be obtained by the esterification of an organic polycarboxylic acid or of a derivative thereof with organic polyols and/or an epoxide. In general, the polycarboxylic acids and polyols are aliphatic or aromatic dibasic acids and diols.

Used as diol in the copolyester diol are preferably alkylene glycols, such as ethylene glycol, neopentyl glycol, or also glycols such as bisphenol A, cyclohexane diol, cyclohexane dimethanol, diols derived from caprolactam, for example, the reaction product of ε-caprolactone and ethylene glycol, hydroxy-alkylated bisphenols, polyether glycols, such as poly(oxytetramethylene)) glycol and the like. Polyols of a higher functionality can also be used. They include, for example trimethylol propane, trimethylol ethane, pentaerythritol, and higher molecular weight polyols, such as those which are produced by the oxyalklation of low molecular polyols.

Monomeric carboxylic acids or anhydrides having 2 to 36 carbon atoms per molecule are preferably used as the acid component in the copolyester diol. Acids which can be used are, for example phthalic acid, isophthalic acid, terephthalic acid, tetrahydrophthalic acid, decanoic diacid, dodecanoic diacid. The polyesters can contain small quantities of monobasic acids, such as benzoic acid, stearic acid, acetic acid and oleic acid. Higher polycarboxylic acids, such as trimellitic acid can also be used.

Medium-length copolyester diols which are preferred according to the invention are marketed by Degussa under the trade names DYNACOLL® 7380 and DYNACOLL® 7390.

Also preferred within the context of the present invention are copolyesters having a molecular weight Mw, determined by GPC, of approximately 5500 and having a hydroxyl number of 18 to 24. A suitable polymer can be obtained, for example from Evonik under the trade name DYNACOLL® 7250.

In an especially preferred embodiment, a low molecular weight polyol is also added to the reaction mixture to form the polyurethane (meth)acrylate particles in addition to a high molecular weight polyol. Accordingly, in a most preferred embodiment, polyurethane (meth)acrylate particles can be obtained by reacting a polyisocyanate with a high molecular weight polyol, a low molecular weight polyol and a hydroxyalkyl(meth)acrylic ester in the reactive diluent.

According to the invention, a “low molecular weight polyol” is understood as meaning a compound which has two or more hydroxy functionalities and a molar mass of 50-500 g/mol, preferably 50-250 g/mol. The molecular weight can be uniform or, in the case of a polymerisation product, it can be distributed statistically, and in the latter case, the molecular weight is understood as meaning the weight average of the molecular weight.

Preferred as the low molecular weight polyol is a polyol which has a uniform molecular weight, aliphatic diols having 2 to 18 carbon atoms, such as ethylene glycol, 1,2-propane diol, 1,3-propane diol, 1,2-butane diol, 1,4-butane diol, 1,2-hexane diol and 1,6-hexane diol, and cycloaliphatic polyols, such as 1,2-cyclohexane diol and cyclohexane dimethanol being especially preferred. Polyols having ether groups can also be used, for example diethylene glycol and triethylene glycol and dipropylene glycol. Examples of low molecular weight polyols having more than two hydroxy groups are trimethylol methane, trimethylol ethane, trimethylol propane, glycerol and pentaerythritol. 1,4-butane diol and 1,3-propane diol are most preferably used as low molecular weight polyols.

It is also possible to use low molecular weight polyols having a statistical distribution of the molecular weight. In principle, it is possible to use as a low molecular weight polyol having a statistical distribution of the molecular weight any polyol which is composed of the same monomeric units as the previously described high molecular weight polyols, but which has a correspondingly lower molecular weight, as stated above. It is quite obvious to a person skilled in the art that the weight average of the molecular weight in the case of a low molecular weight polyol having a statistical molar mass distribution will mainly be close to the upper limit of the previously defined range of 50-500 g/mol.

The low molecular weight polyol having a statistical distribution is preferably a trihydroxyfunctional polyol, more preferably a trihydroxyfunctional polyalkylene glycol and most preferably a trihydroxyfunctional polypropylene glycol. Trihydroxyfunctional polyalkylene glycols of this type expediently have a KOH number within a range of 140 to 600 and preferably within a range of 360 to 500. A suitable trihydroxyfunctional polyalkylene glycol can be obtained, for example from Bayer as Desmophen 1380 BT.

The molar ratio of the hydroxy groups of the low molecular weight trihydroxyfunctional polyalkylene glycols, based on the total molar quantity of the hydroxy groups of the high molecular weight polyols and of the low molecular weight trihydroxyfunctional polyalkylene glycols is preferably 2% to 30% and more preferably 4 to 20%.

Within the context of the invention, it is preferred if the polyol to be included in the polyurethane (meth)acrylate particles has at least one dihydroxyfunctional and at least one trihydroxyfunctional polyol. With regard to the trihydroxyfunctional polyol, it is preferred if it comprises a polyalkylene glycol, preferably a polypropylene glycol. Within the context of the present invention, it is most especially preferred if the polyol comprises a polyether diol having a weight average of the molecular weight of >500 to 5000 g/mol and a polyether triol having a weight average of the molecular weight of >50 to 500 g/mol, the molar quantity of the OH groups of the polyether triol having a weight average of the molecular weight of >50 to 500 g/mol making up approximately 3 to 25%, preferably approximately 5 to 15% of the total of the molar quantity of the polyether diol having a weight average of the molecular weight of >500 to 5000 g/mol and of the polyether triol having a weight average of the molecular weight of >50 to 500 g/mol.

Especially preferred nucleophilically functionalised (meth)acrylic esters are hydroxyfunctional (meth)acrylic esters. According to the invention, a “hydroxyfunctional (meth)acrylic ester” is understood as meaning a (meth)acrylic ester which still carries at least one hydroxy functionality in the radical originating from the alcohol after esterification with the (meth)acrylic ester. In other words, it is the ester of a (meth)acrylic acid and a diol or polyol, diols being preferred.

An especially preferred group of “hydroxyfunctional (meth) acrylic esters” are hydroxyalkyl(meth)acrylic esters. Hydroxyalkyl(meth)acrylic esters which can be used according to the invention are esters of (meth)acrylic acid with dihydric aliphatic alcohols. These compounds are widely known among those skilled in the art. They can be obtained, for example by the reaction of (meth)acrylic acid with oxiranes.

Included among the oxirane compounds are, inter alia, ethylene oxide, propylene oxide, 1,2-butylene oxide and/or 2,3-butylene oxide, cyclohexene oxide, styrene oxide, epichlorohydrin and glycidylester. These compounds can be used on their own or also as a mixture.

The hydroxyalkyl(meth)acrylic esters can also contain substituents, such as phenyl groups or amino groups.

Preferred hydroxyalkyl(meth)acrylic esters are, inter alia, 1-hydroxy-ethylacrylate, 1-hydroxyethylmethacrylate, 2-hydroxyethylacrylate (HEA), 2-hydroxyethylmethacrylate (HEMA), 2-hydroxypropylacrylate, 2-hydroxypropylmethacrylate, 3-hydroxypropylacrylate, 3-hydroxypropylmethacrylate, 6-hydroxy-hexylacrylate and 6-hydroxyhexylmethacrylate, 3-phenoxy-2-hydroxypropylmethacrylate, acrylic acid-(4-hydroxybutylester), methacrylic acid(hydroxymethylamide), caprolactone hydroxyethylmethacrylate and caprolactone hydroxyethylacrylate. Of these, hydroxyethylmethacrylates, hydroxyethylacrylates, 2-hydroxypropylmethacrylate and 2-hydroxypropylacrylate are especially preferred. 2-hydroxyethylmethacrylate and 2-hydroxyethylacrylate are most preferred.

A further preferred group of hydroxyfunctional (meth)acrylic esters are polyethermethacrylates. These are understood as substances which are obtained by esterification of a (meth)acrylic acid with a polyether polyol, preferably with a polyether diol. Polyether polyols of this type have already been mentioned above among the preferred polyols. In the case of polyethermethacrylates, the hydroxyalkyl radical of the ester contains polyoxyalkylene groups which can be linear as well as branched, such as polyethylene oxide, polypropylene oxide and polytetramethylene oxide. These groups often have between 2 and 10 oxyalkylene units. Specific examples are polyethoxy-methacrylate, polypropoxymethacrylate, polyethylene oxide/polytetramethylene oxide-methacrylate, polyethylene oxide/polypropylene oxide methacrylate.

The quantity of nucleophilically functionalised (meth)acrylic ester is selected such that free isocyanate groups which are still present after the polycondensation between polyisocyanate and polyol are completely reacted. In order to determine the optimum quantity of nucleophilically functionalised (meth)acrylic esters, the content of free isocyanate groups can be determined after polycondensation. The content of free isocyanate groups can be determined, for example by infrared spectroscopic methods or by titration.

The polyurethane (meth)acrylate, of which the particles of the dispersion according to the invention are composed, generally has a weight average molecular weight of 3000 to 600 000 g/Mol, preferably of 3000 to 500 000 g/Mol, which is to be determined by GPC.

In the dispersion according to the invention, the polyurethane (meth)acrylate particles have an average diameter of less than 40 nm, thereby achieving the desired transparency. An average particle diameter of less than 20 nm is preferably achieved, an average particle diameter of less than 10 nm is more preferably achieved.

The specified diameters can be determined by light scattering. A person skilled in the art is very familiar with appropriate methods. A suitable device for determining the particle size is for example the Nanosizer manufactured by Malvern.

In the context of the present invention, the solids content is understood as meaning the weight of the polyurethane (meth)acrylate particles, based on the weight of the total dispersion. In the dispersion according to the invention, the solids content is preferably at least 20% by weight. It is also preferred if the solids content is 80% by weight or less. A solids content of 30 to 50% by weight is especially preferred, while 35 to 45% by weight is most preferred, in each case based on the total weight of the dispersion.

In the context of the present invention, in principle it is possible to use as initiator for the polymerisation of the reactive diluent any initiator which allows a polymerisation of the reactive diluent. Examples of initiators which can be used are, for example peroxides and hydroxyperoxides, such as dibenzoyl peroxide, diacetyl peroxide and t-butylhydroperoxide. A further class of initiators are heat-activatable initiators, in particular azo initiators, such as azobisisobutyronitrile. If a peroxide is used as initiator, the decomposition thereof can be induced by means of promoters at low temperatures. In this connection, an especially preferred promoter is N,N-bis-(2-hydroxyethyl)-p-toluidine (DEPT).

In the context of the present invention, a UV-activatable photoinitiator is preferably used as initiator. For photoinitiators of this type, a distinction is generally made between photoinitiators of Norrish type I and Norrish type II. Photoinitiators which are especially preferred in the context of the present invention are those of Norrish type I. Examples of such photoinitiators are 2-hydroxy-2-methyl-1-phenyl-propan-1-on (obtainable from Ciba under the name of Darocure® 1173) or 1-hydroxycyclo-hexylphenylketone which can be obtained from Ciba as Irgacure® 500 mixed with benzophenone (1:1). The quantity of added photoinitiator is not subject to any substantial restrictions, but it should not exceed 10% by weight, based on the total weight of the coating composition, as otherwise an influence on the characteristics of the coating composition cannot be ruled out. Preferred contents of the photoinitiator are within a range of approximately 1 to 6% by weight, and more preferably approximately 2 to 4.5% by weight.

In addition to the constituents described above, the coating composition according to the present invention can also contain suitable additives, especially in the form of defoaming agents, solvents and/or film formers. A suitable defoaming agent is for example Byk 141 manufactured by Byk. Defoaming agents are normally effective even in small quantities so that the content of defoaming agent in the coating composition according to the invention should not exceed 3%. A content of defoaming agent within a range of 0.5 to 1% by weight, based on the total weight of the coating composition is preferred.

Furthermore, the coating composition can contain a solvent, such as in particular butyl acetate. With regard to the quantity of solvent, the coating composition is also not subject to any substantial restrictions, although it is expedient to use the solvent in quantities which do not exceed 50% by weight, based on the total weight of the coating composition. In one embodiment, the coating composition according to the invention is free from solvent. In another embodiment, the coating composition according to the invention contains 20 to 50% by weight, in particular 30 to 50% by weight of solvent, preferably in the form of butyl acetate. Depending on the application method, the use of organic solvents can be desirable so that the processing parameters, such as viscosity, wet/dry layer thickness and run of the coating can be adapted to the user's requirements. The preferred application methods are, for example doctoring, rolling, pouring, vacuumat methods, dipping, tumbling, spraying (cup gun, airless, airmix).

Furthermore, it can be expedient to add film formers to the coating composition according to the invention. Suitable film formers are, for example cellulose derivatives. Cellulose esters are especially suitable film formers, especially cellulose acetobutyrate.

Further suitable film formers are, for example high molecular, partially hydrolysed polyvinylchlorides/vinylacetate resins (for example mixed polymers under trade mark UCAR™ VAGH manufactured by Dow Chemical Company).

The viscosities of the coating compositions according to the invention are generally between 50 and 1000 mPa·s, measured rheologically with a cone and plate geometry at a shear rate of 100 s⁻¹ and T=25 to 26° C. The viscosity is preferably between 50 and 500 mPa·s, more preferably between approximately 80 and 300 mPa·s, and most preferably approximately 100 to 250 mPa·s. A “coating specialist” also talks about the efflux time in seconds which is determined using a flow cup according to DIN 53211. According to DIN 53211, only a flow cup with an efflux nozzle of 4 mm diameter is standard. The coating compositions according to the invention generally have efflux times of approximately 25-250 s, preferably between 30-180 s.

In a further embodiment, the present invention also relates to a non-aqueous transparent dispersion of polyurethane (meth)acrylate particles in specific reactive diluents, which can be obtained by reacting a polyisocyanate with at least one polyol and a nucleophilically functionalised (meth)acrylic ester in these reactive diluents. The specific reactive diluents include methylmethacrylate (MMA), isobornyl acrylate (IBOA), hexane diol diacrylate (HDDA), dipropylene glycol diacylate and tripropylene glycol diacrylate. Dispersions of this type are transparent and remain transparent even after the reactive diluent has cured. In addition to being used as a coating, this dispersion can also be cured to form an adhesive bond or a cast body. Apart from a curing initiator, no further substances have to be added. However, of course it is possible to mix the dispersion according to the invention into conventional formulations of adhesive systems, lacquers, coatings or casting compounds, as described to some extent above, and to then cure the formulation.

In the context of the aspect, described above, of the present invention, the following are to be used as reactive diluent, as mentioned above: methylmethacrylate, isobornyl acrylate and hexane diol diacrylate or dipropylene glycol diacrylate or tripropylene glycol diacrylate as well as low molecular (multifunctional) polyetheracrylates. However, it is also possible to use meth(acrylates) such as 2-ethylhexylacrylate or tetrahydrofurfurylmethacrylate as reactive diluent. Furthermore, the compounds stated in DE 102005035235 A1 in [0031] are considered as reactive diluents.

Tetramethylene diisocyanate (TMDI), toluylene diisocyanate (TDI) and isophorone diisocyanate (IPDI) in particular are included among the polyisocyanates which can be used in the above-described aspect of the present invention.

In an especially preferred embodiment of an non-aqueous transparent dispersion according to the aspect described above, the polyurethane (meth)acrylate particles can be obtained from tetramethylene diisocyanate as polyisocyanate, a copolyester having a molecular weight of approximately 5,500 and a hydroxy number of 18 to 24 and also 1,4-butane diol as polyols, and from hydroxyethylmethacrylate as nucleophilically functionalised (meth)acrylic ester. In this case, the reactive diluent preferably consists of methylmethacrylate. It is most especially preferred if the dispersion is based on polyurethane particles which can be obtained from approximately 6% by weight of polymethylene diisocyanate, approximately 46% by weight of the copolyester having a Mw of 5,500 and a hydroxy number of 18 to 24, approximately 1% by weight of 1,4-butane diol and approximately 4% by weight of hydroxyethylmethacrylate, as well as 43% by weight of methylmethacrylate as reactive diluent. Here and in the following, the term “approximately” includes a range of ±1% by weight, preferably ±0.5% by weight. The weight information relates to the total weight of the dispersion in each case.

In an alternative preferred embodiment according to the aspect described above, the non-aqueous transparent dispersion is based on polyurethane particles of toluylene diisocyanate as polyisocyanate, polytetrahydrofuran having an average molecular weight of approximately 2,000 as polyol, and hydroxyethylacrylate as nucleophilically functionalised (meth)acrylic ester and also isobornylacrylate as reactive diluent. In this respect, it is again preferred if the dispersion is based on polyurethane particles which can be obtained from approximately 4% by weight of toluylene diisocyanate, approximately 27% by weight of polytetrahydrofuran having an average molecular weight of approximately 2000 and approximately 4% by weight of hydroxyethylacrylate, and approximately 65% by weight of isobornyl acrylate as reactive diluent

In a further preferred embodiment according to the aspect described above, the non-aqueous transparent dispersion is based on polyurethane particles of isophorone diisocyanate as polyisocyanate, a mixture of polytetrahydrofuran having an average molecular weight of approximately 2000 and 1,4-butane diol as polyol and hydroxyethylacrylate as nucleophilically functionalised (meth)acrylic ester and also on hexane diol diacrylate as reactive diluent. In this respect, it is again preferred if the dispersion is based on polyurethane particles which can be obtained from approximately 12% by weight of isophorone diisocyanate, approximately 28% by weight of the polytetrahydrofuran having an average molecular weight of approximately 2000, approximately 2% by weight of 1,4-butane diol, and approximately 4% by weight of hydroxyethyl acrylate, and approximately 54% by weight of hexane diol diacrylate as reactive diluent.

In the embodiment described above, the polyol can optionally also contain trimethylolpropane or a trihydroxyfunctional polypropylene glycol having a KOH-number of approximately 385 mg KOH/g. For mixtures of this type, it is preferred if the molar quantity of OH groups of the trimethylolpropane or of the trihydroxyfunctional polypropylene glycol makes up approximately 5 to 15% of the total of the molar quantity of the OH groups of the polytetrahydrofuran having an average molecular weight of approximately 2000 and the trimethyolpropane or the trihydroxyfunctional polypropylene glycol.

In a further aspect, the invention relates to a production process for the coating composition described at the outset. In this process, a polyisocyanate is reacted in a stirrer vessel with at least one polyol and a nucleophilically functionalised (meth)acrylic ester in a reactive diluent. These constituents have been described in detail above. The coating composition according to the invention can then be obtained by adding an initiator to the reaction mixture, before or after polymerisation of the polyisocyanate. A suitable process for producing polyurethane (meth)acrylate particles is described, for example, in DE 10 2005 035 235 A1 in [0098] to [0112].

A further aspect of the present invention relates to a coated substrate which can be obtained by applying a coating composition, as described above, to the substrate and by curing the composition on the substrate. The substrate is expediently glass, metal, preferably with a surface of aluminium, zinc or iron, and plastics, preferably PVC or polycarbonate. When metals which have a surface of aluminium, zinc or iron are mentioned above, this means that the surface substantially consists of elementary aluminium, zinc or iron, except for unavoidable oxidation products of aluminium, zinc or iron.

A further aspect of the present invention relates to a process for producing a coated substrate, comprising applying a coating composition, as described above, to a substrate and curing the coating composition on the substrate. It is preferred if the composition is cured using UV radiation, which implies that a UV light-activatable initiator is used as the initiator.

When cured, as mentioned above, the coating composition according to the invention not only has a high transparency, but also a good adhesion strength, especially on substrates such as glass, metals or plastics material, as well as a high degree of hardness and a high resistance to micro-scratches.

The dispersions, described above, of polyurethane (meth)acrylate particles in specific reactive diluents can also be processed into mouldings, and thus a further aspect of the present invention relates to mouldings produced from corresponding dispersions.

In the following, the invention is illustrated by examples, although these examples should not be understood as restricting the inventive idea.

### EXAMPLES

### Production of Polyurethane/Reactive Diluent Dispersions

Component II (cf. the following Tables 1 to 10) was added dropwise to component I in a glass reactor at 60° C. via a dropping funnel, the temperature of which was kept at 60° C., and was stirred at a stirring speed of 14.9 m/s. Thereafter, the catalyst (component III, dibutyl tin dilaurate) was added to the reaction mixture and the mixture was stirred for 1 h at a stirring speed of 14.9 m/s. Lastly, component IV was added to the resulting mixture and the mixture was cooled to 23° C.

The compositions of the different batches are stated in the following Tables 1 to 10.

TABLE 1
Coating base 1

| Component | Substance | Quantity [g] |
|---|---|---|
| I | IPDI | 58.29 |
| | HDDA | 170.32 |
| II | PTHF 2000 | 140.76 |
| | 1,4-Butanediol | 7.49 |
| | HDDA | 100.45 |
| III | DBTDL | 0.44 |
| IV | HEA | 22.18 |

TABLE 2
Coating base 2

| Component | Substance | Quantity [g] |
|---|---|---|
| I | IPDI | 59.17 |
| | HDDA | 172.29 |
| II | PTHF 2000 | 135.28 |
| | 1,4-Butanediol | 7.58 |
| | HDDA | 101.44 |
| | Desmophen 1380 BT | 1.04 |
| III | DBTDL | 0.44 |
| IV | HEA | 22.74 |

TABLE 3
Coating base 3

| Component | Substance | Quantity [g] |
|---|---|---|
| I | IPDI | 59.90 |
| | HDDA | 174.41 |
| II | PTHF 2000 | 129.73 |
| | 1,4-Butanediol | 7.67 |
| | HDDA | 102.68 |
| | Desmophen 1380 BT | 2.11 |
| III | DBTDL | 0.46 |
| IV | HEA | 23.02 |

TABLE 4
Coating base 4

| Component | Substance | Quantity [g] |
|---|---|---|
| I | IPDI | 60.64 |
| | HDDA | 176.58 |
| II | PTHF 2000 | 124.06 |
| | 1,4-Butanediol | 7.76 |
| | HDDA | 103.96 |
| | Desmophen 1380 BT | 3.21 |
| III | DBTDL | 0.47 |
| IV | HEA | 23.31 |

TABLE 5
Coating base 5

| Component | Substance | Quantity [g] |
|---|---|---|
| I | IPDI | 60.92 |
| | HDDA | 177.38 |
| II | PTHF 2000 | 124.61 |
| | 1,4-Butanediol | 7.80 |
| | HDDA | 104.43 |
| | Trimethylolpropane | 0.98 |
| III | DBTDL | 0.47 |
| IV | HEA | 23.42 |

In addition, two compositions were produced which contained methylmethacrylate (MMA) or isobornyl acrylate (IBOA) instead of HDDA.

TABLE 6

| Component | Substance | Quantity [g] |
|---|---|---|
| I | TMDI | 46.55 |
| | MMA | 190.23 |
| II | Dynacoll 7250 | 325.67 |
| | 1,4-Butanediol | 6.3 |
| | MMA | 112.08 |
| III | DBTDL | 0.38 |
| IV | HEMA | 25.11 |

TABLE 7

| Component | Substance | Quantity [g] |
|---|---|---|
| I | TDI | 18.73 |
| | IBOA | 188.55 |
| II | PTHF 2000 | 123.12 |
| | IBOA | 110.87 |
| III | DBTDL | 0.10 |
| IV | HEA | 16.80 |

The dispersions produced according to the formulations of Tables 6 and 7 were clear, colourless liquids.

The different coating base compositions were formulated into coatings for adhesive strength tests, the compositions of which coatings are stated in the following Table 8:

TABLE 8

| Raw | | | | | | Comparison |
|---|---|---|---|---|---|---|
| materials | Coating 1 | Coating 2 | Coating 3 | Coating 4 | Coating 5 | coating 1 |
| Coating | 96.00 | — | — | — | — | — |
| base 1 | | | | | | |
| (40% in | | | | | | |
| HDDA | | | | | | |
| Coating | — | 90.60 | — | — | — | — |
| base 2 | | | | | | |
| (43% in | | | | | | |
| HDDA) | | | | | | |
| Coating | — | — | 90.60 | — | — | — |
| base 3 | | | | | | |
| (43% in | | | | | | |
| HDDA) | | | | | | |
| Coating | — | — | — | 91.40 | — | — |
| base 4 | | | | | | |
| (42% in | | | | | | |
| HDDA) | | | | | | |
| Coating | — | — | — | — | 91.40 | — |
| base 5 | | | | | | |
| (42% in | | | | | | |
| HDDA) | | | | | | |
| Desmolux | — | — | — | — | — | 38.40 |
| 2740 | | | | | | |
| (100%) | | | | | | |
| HDDA | — | 5.40 | 5.40 | 4.60 | 4.60 | 57.60 |
| Darocur | 4.00 | 4.00 | 4.00 | 4.00 | 4.00 | 4.00 |
| 1173 | | | | | | |
| | 100 | 100 | 100 | 100 | 100 | 100 |
| Content | 40 | 40 | 40 | 40 | 40 | 40 |
| UV resin | | | | | | |
| on100% | | | | | | |
| Content | 60 | 60 | 60 | 60 | 60 | 60 |
| HDDA on | | | | | | |
| 100% | | | | | | |
| Content of | | 5% | 10% | 15% | 15% Tri- | |
| tri- | | Desmophen | Desmophen | Desmophen | methylol- | |
| functional | | 1380 | 1380 | 1380 | propane | |
| polyol | | | | | | |

The adhesive strength of the coating formulations according to the invention and of a comparison coating based on Desmolux 2740 on different substrates was tested in accordance with DIN EN ISO 2409 (characteristic value ISO GT0-GT5). In this respect, GTO means a very good adhesive strength, GT5 means complete separation/poor adhesive strength. The results of these tests are shown in the following Table 9.

TABLE 9

| | | | | | | Comparison |
|---|---|---|---|---|---|---|
| Adhesive strength | Coating 1 | Coating 2 | Coating 3 | Coating 4 | Coating | coating 1 |
| Glass (30 μm) | GT 2 | GT 2-3 | GT 3 | GT 4 | GT 4 | GT 5 |
| Glass (100 μm) | GT 1-2 | GT 4 | GT 4 | GT 5 | GT 5 | GT 5 |
| Aluminium sheet | GT 4 | GT 4 | GT 4 | GT 3-4 | GT 4-5 | GT 5 |
| (12 μm) | | | | | | |
| Galvanised sheet | GT 3 | GT 2 | GT 3 | GT 3-4 | GT 2-3 | GT 4 |
| (12 μm) | | | | | | |
| Steel sheet (12 μm) | GT 4 | GT 4 | GT 4 | GT 5 | GT 5 | GT 4-5 |
| PVC film black (30 μm) | GT 0 | GT 0 | GT 0 | GT 0 | GT 2 | GT 4-5 |
| PVC film black | GT 0 | GT 0 | GT 0 | GT 0 | GT 1-2 | GT 4-5 |
| (100 μm) | | | | | | |
| Polycarbonate sheet | GT 0 | GT 0 | GT 0 | GT 0-1 | GT 0 | GT 3-4 |
| black (100 μm) | | | | | | |
| BayerMaterialScience | | | | | | |

Coating 1 displays the best results in respect of overall performance (adhesive strength). The comparison coating 1 based on Desmolux 2740 displays the poorest results in this series of tests. There are tendencies which show that as the polyol content (trifunctional) increases, the adhesive strengths become slightly less favourable (coatings 2 to 5).

It is also seen that all the coating formulations coating 1 to coating 5 according to the invention have improved adhesive strengths on all the tested substrates compared to the commercially available product based on Desmolux 2724. The best adhesive strengths could be observed in the case of formulation coating 1. All the coatings: coating 1 to coating 5 according to the invention exhibit very high adhesive strengths on polycarbonate sheets and on PVC films.

Furthermore, the pendulum damping in seconds according to Konig was determined on the formulations coating 1 to coating 5 and on the comparison coating 1 (determined in accordance with DIN 53157 with 100 μm wet application). The results of these tests are shown in Table 10 as oscillation duration in seconds:

TABLE 10

| | Coat- | | Coat- | | Coat- | Comparison |
|---|---|---|---|---|---|---|
| | ing 1 | Coating 2 | ing 3 | Coating 4 | ing 5 | coating 1 |
| Pendulum | 89 | 98 | 89 | 87 | 102 | 102 |
| damping | | | | | | |
| [s] | | | | | | |

In the tests, the lowest pendulum damping values were exhibited by formulations Coating 1 and Coating 4, with the pendulum damping values in the coating series Coating 2 to Coating 4 decreasing with an increasing content of trifunctional polyol.

Furthermore, the resistance of a coating formulation according to the invention to micro-scratches was determined. The formulations which were tested are shown in the following Table 11.

TABLE 11

| Raw materials | Coating 6 | Comparison coating 2 |
|---|---|---|
| Coating base 1 | 60.00 | — |
| (40% in HDDA) | | |
| Desmolux 2740 | — | 24.00 |
| (100%) | | |
| Byk 141 | 0.63 | 0.63 |
| (Defoaming agent) | | |
| HDDA | — | 36.00 |
| (Reactive diluent) | | |
| Butylacetate | 33.06 | 33.06 |
| (solvent) | | |
| CAB-381-0.5 | 3.65 | 3.65 |
| (Film former) | | |
| Darocure 1173 | 1.86 | 1.86 |
| Irgacure 500 | 0.80 | 0.80 |
| | 100 | 100 |

For a comparative test, Coating 6 (diol) and Comparison Coating 2 based on Desmolux 2740 were tested.

In the following, the resistance to micro-scratches was determined according to the IHD works standard W-466. This standard applies to furniture surfaces and is used for the uniform determination of the resistance of the uppermost coating layer to micro-scratches. Testing was performed using a mini Martindale device. The test bodies were stressed by 5 Lissajous movements (a Lissajous movement corresponds to 16 cycles of defined friction plate movements according to methods A and B in accordance with IHD works standard 466). The Scotch Brite abrasive materials 7447 (very fine) and 7448 (ultra fine) were used as abrasives. Testing was performed at a test force of 6 N according to method A (evaluation by determining the change in gloss). The tests produced the results which are shown in Table 12.

TABLE 12

| | | Classification |
|---|---|---|
| Variant | Change in gloss in % | according to method A |
| Coating 6 | 10.5 | 1 |
| Comparison coating 2 | 6.3 | 1 |

Coating 6 and comparison coating 2 based on Desmolux 2740 exhibit a comparably low change in gloss of 10.5% and 6.3%.

What is claimed is:

1. A coating composition in the form of a non-aqueous transparent dispersion, comprising
a reactive diluent
polyurethane (meth)acrylate particles obtainable by reacting at least one polyisocyanate with at least one polyol and at least one nucleophilically functionalised (meth)acrylic ester in the reactive diluent to produce polyurethane (meth)acrylate particles having an average diameter of less than 40 nm, and
an initiator.

2. A coating composition according to claim 1, characterised in that the reactive diluent comprises a polyfunctional (meth)acrylate.

3. A coating composition according to claim 1, characterised in that the at least one polyisocyanate to be included in the polyurethane (meth)acrylate particles comprises an aliphatic polyisocyanate.

4. A coating composition according to claim 1, characterised in that the at least one polyol to be included in the polyurethane (meth)acrylate particles comprises at least one dihydroxyfunctional and at least one trihydroxyfunctional polyol.

5. A coating composition according to claim 4, characterised in that the trihydroxyfunctional polyol comprises a polyalkylene glycol.

6. A coating composition according to claim 1, characterised in that the at least one polyol comprises a polyether diol having a weight average of the molecular weight of 500 to 5000 g/mol and a polyether triol having a weight average of the molecular weight of 50 to 500 g/mol, the molar quantity of the OH groups of the polyether triol having a weight average of the molecular weight of 50 to 500 g/mol making up 3 to 25% of the total of the molar quantity of the polyether diol having a weight average of the molecular weight of 500 to 5000 g/mol and of the polyether triol having a weight average of the molecular weight of 50 to 500 g/mol.

7. A coating composition according to claim 1, characterised in that the content of polyurethane (meth)acrylate particles is 30 to 50% by weight based on the total weight of the dispersion.

8. A coating composition according to claim 1, characterised in that the initiator is a UV activatable photoinitiator, in particular of Norrish type I.

9. A coating composition according to claim 1, characterised in that the composition contains at least one additive, selected from the group consisting of defoaming agents, solvents and film formers.

10. A coating composition according to claim 9, characterised in that the film former is a cellulose derivative.

11. A coating composition according to claim 1, characterised in that the composition has a viscosity of 50 to 500 mPas and the viscosity is to be determined rheologically using a cone and plate geometry at a shear rate of 100 s⁻¹ and T=25 to 26° C.

12. A coated substrate, obtainable by applying a coating composition described in claim 1, to the substrate and by curing the composition on the substrate.

13. A coated substrate, characterised in that the substrate comprises glass, metal, and plastics.

14. A method for producing a coated substrate comprising
applying the coating composition of claim 1, to a substrate, and
curing the coating composition on the substrate,

15. A method according to claim 14, wherein the composition is cured by UV radiation.
